(19) United States
(12) Patent Application Publication
(10) Pub. No.: US 2025/0209931 A1
(43) Pub. Date: Jun. 26, 2025

(54) INFORMATION PROCESSING APPARATUS, INFORMATION PROCESSING METHOD, AND PROGRAM

(71) Applicant: SONY GROUP CORPORATION, TOKYO (JP)

(72) Inventor: NAOYUKI KAWABATA, TOKYO (JP)

(21) Appl. No.: 18/849,183

(22) PCT Filed: Feb. 14, 2023
(86) PCT No.: PCT/JP2023/004997

§ 371 Date: Sep. 20, 2024

(30) Foreign Application Priority Data
Mar. 29, 2022 (JP) 2022-053416

(51) Int. Cl. G09B 5/02; G06V 40/16

(52) U.S. Cl. CPC G09B 5/02; G06V 40/168

(57) ABSTRACT

[Problem] To accurately estimate intensity of a user's attention and a spatial extent of the attention.

[Solution] An information processing apparatus includes an estimation unit that estimates a level of attention of a user to output information of a certain type on a basis of a physical state of the user. The estimation unit estimates the level of attention using an estimation model that determines a degree of change in an output mode of the output information on a basis of a physical state of a trainer and an experience of whether or not the trainer has perceived a change in an output mode of training information of the same type as that of the output information in a case where the output mode has been changed.

### TECHNICAL FIELD

The present disclosure relates to an information processing apparatus, an information processing method, and a program.

### BACKGROUND ART

In recent years, techniques for estimating how much attention a user is paying to output information have been developed. Patent Document 1, for example, discloses a technique for estimating a level of attention of a user on the basis of a change in eye movement of the user with respect to a change in displayed information.

### CITATION LIST

### Patent Document

Patent Document 1: Japanese Patent Application Laid-Open No. 2019-111291

### SUMMARY OF THE INVENTION

### Problems to be Solved by the Invention

It is difficult, however, to say that the technique disclosed in Patent Document 1 can sufficiently consider intensity of attention and a spatial extent of the attention.

### Solutions to Problems

A certain aspect of the present disclosure provides an information processing apparatus including an estimation unit that estimates a level of attention of a user to output information of a certain type on a basis of a physical state of the user. The estimation unit estimates the level of attention using an estimation model that determines a degree of change in an output mode of the output information on a basis of a physical state of a trainer and an experience of whether or not the trainer has perceived a change in an output mode of training information of the same type as that of the output information in a case where the output mode has been changed.

In addition, another aspect of the present disclosure provides an information processing method including estimating, using a processor, a level of attention of a user to output information of a certain type on a basis of a physical state of the user. In the estimating, the level of attention is estimated using an estimation model that determines a degree of change in an output mode of the output information on a basis of a physical state of a trainer and an experience of whether or not the trainer has perceived a change in an output mode of training information of the same type as that of the output information in a case where the output mode has been changed.

In addition, another aspect of the present disclosure provides a program causing a computer to function as an information processing apparatus including an estimation unit that estimates a level of attention of a user to output information of a certain type on a basis of a physical state of the user. The estimation unit estimates the level of attention using an estimation model that determines a degree of change in an output mode of the output information on a basis of a physical state of a trainer and an experience of whether or not the trainer has perceived a change in an output mode of training information of the same type as that of the output information in a case where the output mode has been changed.

### BRIEF DESCRIPTION OF DRAWINGS

FIG. 1 is a diagram for describing a change in an output mode of training information 310 and pointing out of the change in the output mode by a trainer 20 according to an embodiment.

FIG. 2 is a diagram for describing an outline of a learning cycle of an estimation model 155 according to the embodiment.

FIG. 3 is a block diagram illustrating a configuration example of an information processing apparatus 10 according to the embodiment.

FIG. 4 is a sequence diagram illustrating an example of a procedure of deep reinforcement learning of the estimation model 155 according to the embodiment.

FIG. 5 is a diagram for describing dummy information according to the embodiment.

FIG. 6 is a sequence diagram illustrating an example of a procedure of calculation of a level of attention that uses the estimation model 155 and display control based on the level of attention according to the embodiment.

FIG. 7 is a diagram for describing an example of control of dynamic display of continuously estimated levels of attention according to the embodiment.

FIG. 8 is another diagram for describing the example of the control of the dynamic display of continuously estimated levels of attention according to the embodiment.

FIG. 9 is a diagram for describing an example of output control of each of a plurality of pieces of content based on a level of attention to the piece of content according to the embodiment.

FIG. 10 is a diagram for describing an example of display control of a display object based on a level of attention according to the embodiment.

FIG. 11 is a diagram for describing an example of output control based on a level of attention of each of a plurality of users 30 according to the embodiment.

FIG. 12 is a block diagram illustrating an example of hardware configuration of an information processing apparatus 90 according to the embodiment.

### MODE FOR CARRYING OUT THE INVENTION

Preferred embodiments of the present disclosure will be described in detail hereinafter with reference to the accompanying drawings. Note that, in the present description and the drawings, constituent elements having substantially the same functional configurations will be given the same reference signs, and redundant description thereof will be omitted.

Note that the description will be given in the following order.
1. Embodiment
1.1. Outline
1.2. System Configuration Example
1.3. Procedure of Deep Reinforcement Learning of Estimation Model 155
1.4. Procedure of Calculation of Level of Attention That Uses Estimation Model 155 and Display Control Based on Level of Attention
1.5. Specific Examples of Display Control Based on Level of Attention
2. Hardware Configuration Example
3. Conclusion

### 1. Embodiment

### 1.1. Outline

First, an outline of an embodiment of the present disclosure will be described. During these years, there is a need to estimate how much attention a user is paying to information that is being output (hereinafter referred to as output information).

For example, there is a need to grasp which information displayed on a screen a user is paying attention to in an online meeting involving information display.

By accurately estimating an area to which a user is paying attention and a degree (intensity) of attention, for example, it is possible to gain various advantages such as grasping information in which the user is interested and, conversely, grasping information overlooked by the user.

Here, in a case where it is simply desired to grasp which point on the screen the user is viewing, various line-of-sight estimation techniques can be used.

Information obtained by a general line-of-sight estimation technique, however, is only a coordinate position at an end of a line of sight. Moreover, there are cases where a person is not paying attention to what he/she is looking at and cases where a person is paying close attention to a certain object even while he/she is not looking at the object. It is, therefore, extremely difficult to accurately estimate a level of attention of a user only on the basis of his/her line of sight.

In addition, Patent Document 1 discloses a technique for estimating a level of attention of a user on the basis of a speed of the user's reaction to a change in information displayed at a certain position.

The technique disclosed in Patent Document 1, however, does not take into consideration a degree of change that the user can notice and an area of change on a screen that the user can notice. For this reason, in the technique disclosed in Patent Document 1, it is difficult to accurately estimate intensity of the user's attention and a spatial extent of the attention.

In addition, as another method for estimating a level of attention of a user, for example, a method in which gaze time of the user is focused on is also conceivable.

In a case where it is defined that the more the user gazes at a certain object, the more attention the user is paying to the object, however, it is difficult to estimate the level of attention in a situation where the user is paying close attention to an object although the gaze time is short or a situation where the user is not gazing but captures an object in a peripheral field of view and is paying attention to the object.

Alternatively, a method is also conceivable in which information indicating a certain state and correct data regarding a level of attention of a user in the state are prepared and the information and the correct data are learned in pairs.

It is difficult, however, for even the user himself/herself to create correct data that quantitatively reflects intensity of attention and a spatial extent of the attention.

A technical idea according to an embodiment of the present disclosure has been conceived by focusing on each of the above-described points, and enables accurate estimation of intensity of a user's attention and a spatial extent of the attention.

For this purpose, an information processing apparatus 10 according to an embodiment of the present disclosure includes an estimation unit 150 that estimates a level of attention of a user to output information of a certain type on the basis of a physical state of the user. In addition, one of features of the estimation unit 150 according to the embodiment of the present disclosure is to estimate a level of attention using an estimation model 155 that determines a degree of change in an output mode of output information on the basis of a physical state of a trainer and an experience of whether or not the trainer has perceived a change in an output mode of training information of the same type as that of the output information in a case where the output mode has been changed.

Here, the certain type refers to a type of sensation of perceiving the output information. That is, the output information according to the present embodiment may be visual information, auditory information, tactile information, or the like. Note that, in the following description, a case where the output information is visual information, that is, visually perceived information, will be described as a main example.

First, an outline of learning of the estimation model 155 according to the present embodiment will be described. A deep reinforcement learning method with a neural network, for example, is used to learn the estimation model 155 according to the present embodiment.

As described above, the estimation model 155 according to the present embodiment is subjected to learning for determining a degree of change in an output mode of output information (training information) on the basis of a physical state of a trainer and an experience of whether or not the trainer has perceived a change in an output mode of the training information in a case where the output mode has been changed.

For example, the estimation model 155 according to the present embodiment may be subjected to learning for determining, on the basis of the above experience, a degree of change in an output mode of training information such that the trainer will not perceive the change in the output mode of the training information, instead.

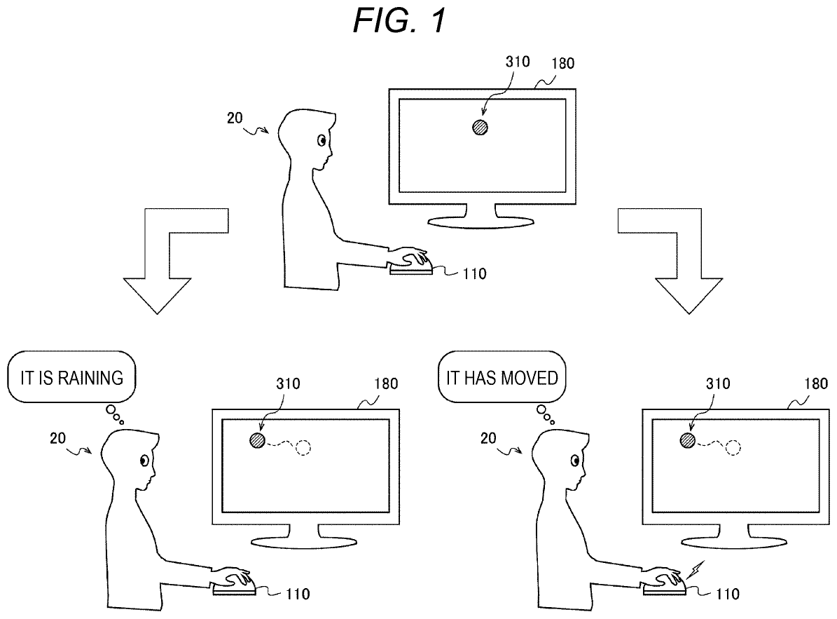

FIG. 1 is a diagram for describing a change in an output mode of training information 310 and pointing out of the change in the output mode by a trainer 20 according to the present embodiment.

Note that FIG. 1 illustrates a case where the output mode of the training information 310 is an output (display) position. The above, however, is merely an example, and in a case where the output information is visual information, the output mode of the training information 310 includes presence/absence, shape, color, brightness, and the like.

A upper part of FIG. 1 illustrates the training information 310 displayed on a display unit 180 and the trainer 20 gripping a pointing unit 110.

The pointing unit 110 according to the present embodiment is used to point out a change in the output mode of the training information 310 (i.e., report that the trainer 20 has perceived a change in the output mode of the training information 310) in a case where the trainer 20 has noticed the change in the output mode.

The pointing unit 110 according to the present embodiment may be, for example, a mouse or the like.

As illustrated in a lower-right part of FIG. 1, for example, in a case where the trainer 20 notices a change in the output mode of the training information 310, the trainer 20 operates the pointing unit 110 to point out the change in the output mode.

As illustrated in a lower-left part of FIG. 1, on the other hand, in a case where the trainer does not notice a change in the output mode of the training information 310, the trainer does not point out a change as described above.

The estimation model 155 according to the present embodiment is subjected to learning for determining a degree of change in the output mode of the training information 310 on the basis of a physical state of the trainer 20 and presence or absence of pointing out in a case where the output mode of the training information 310 is changed.

In a case where the trainer 20 does not point out a change in the output mode of the training information 310 (i.e., the trainer 20 does not notice the change), for example, a higher reward may be given to the estimation model 155 as the degree of change in the output mode becomes higher.

In the case of the example illustrated in FIG. 1, a higher reward may be given to the estimation model 155 as a speed of change in the display position (movement speed on the display unit 180) of the training information 310 becomes higher and the amount of change in the display position (a movement distance on the display unit 180) of the training information 310 becomes larger.

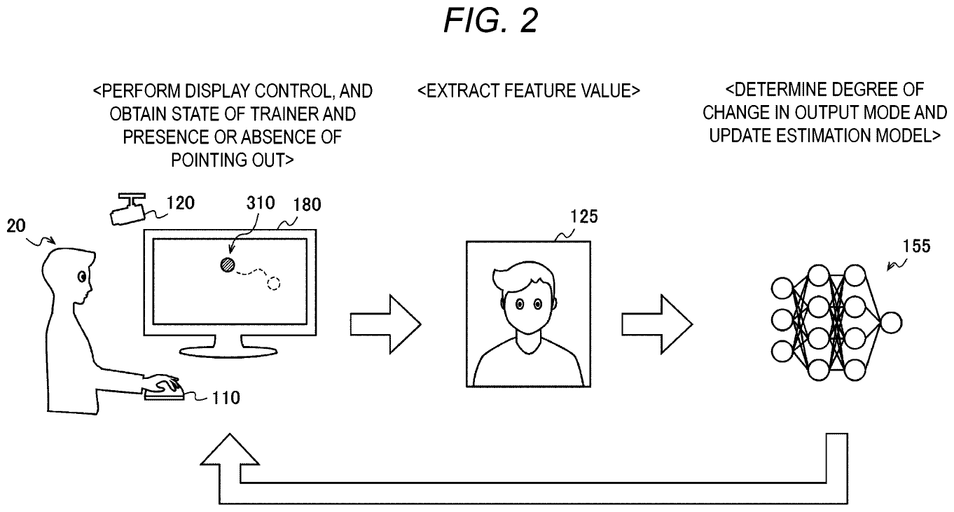

FIG. 2 is a diagram for describing an outline of a learning cycle of the estimation model 155 according to the present embodiment.

In the learning of the estimation model 155 according to the present embodiment, first, display control of training information is performed on the basis of the degree of change in the output mode of the training information 310 determined by the estimation model 155 illustrated on a left side of FIG. 2.

In a case where the trainer 20 perceives a change in the output mode of the training information 310, the trainer 20 operates the pointing unit 110 to point out the change.

In addition, at this time, a state obtaining unit 120 obtains sensor information 125 indicating physical information regarding the trainer 20.

In the case of the example illustrated in FIG. 2, the sensor information 125 may be an image obtained by capturing an image of a face of the trainer 20. In addition, in this case, the state obtaining unit 120 may be a camera.

Next, as illustrated in the center of FIG. 2, a feature value extraction unit 130 extracts, from the sensor information 125, a feature value relating to the physical state of the trainer 20.

In a case where the sensor information 125 is an image obtained by capturing an image of the face of the trainer 20, the feature value may include, for example, a position of eyes, a line of sight, a position of the face, an orientation of the face, a facial expression, a posture, magnitude of a motion, and the like of the trainer 20.

Next, as illustrated on a right side of FIG. 2, the estimation model 155 determines a degree of change in the output mode of the training information 310 on the basis of input presence or absence of pointing out, a feature value, and the like, and the estimation model 155 is updated.

Thereafter, the display control of the training information 310 is performed on the basis of the determined degree of change in the output mode, and the above-described cycle is repeatedly performed until an end of the learning.

As described above, one of features of the learning of the estimation model 155 according to the present embodiment is that the learning is performed while obtaining pointing out (feedback), by the trainer 20, of a change in the output mode of the training information 310 in real-time.

With the above-described method, it is possible to perform the learning while associating a minimum degree of change in the output mode of the training information 310 with which the trainer 20 can perceive the change in the output mode (i.e., intensity of attention) with the physical state of the trainer 20.

In addition, with the above-described method, it is possible to perform the learning while associating whether the trainer 20 can perceive a change in the output mode of the training information 310 in a certain area (i.e., a spatial extent of attention) with the physical state of the trainer 20.

### 1.2. System Configuration Example

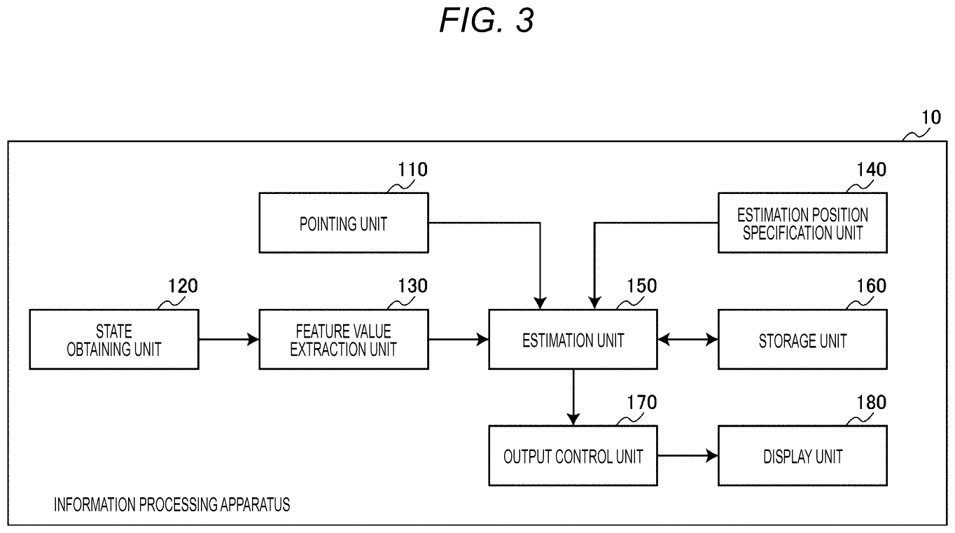

Next, a configuration example of a system according to the present embodiment will be described. A system according to the present embodiment includes the information processing apparatus 10. FIG. 3 is a block diagram illustrating a configuration example of the information processing apparatus 10 according to the present embodiment.

As illustrated in FIG. 3, the information processing apparatus 10 according to the present embodiment may include the pointing unit 110, the state obtaining unit 120, the feature value extraction unit 130, an estimation position specification unit 140, the estimation unit 150, a storage unit 160, an output control unit 170, and the display unit 180.

In addition, the information processing apparatus 10 according to the present embodiment may be a personal computer (PC), a smartphone, a tablet, a head-mounted device, a gaming machine, or the like.

### Pointing Unit 110

The pointing unit 110 according to the present embodiment is used to point out a change in the output mode of the training information 310 when the trainer 20 perceives the change in the output mode.

The pointing unit 110 according to the present embodiment may be, for example, a mouse, a keyboard, a controller, a button, a lever, a voice recognizer, a gesture recognizer, or the like.

### State Obtaining Unit 120

The state obtaining unit 120 according to the present embodiment obtains a physical state of the trainer 20 or a user 30. For this purpose, the state obtaining unit 120 according to the present embodiment includes various sensors.

Examples of the sensor include an imaging sensor, an infrared sensor, an acceleration sensor, a gyro sensor, a microphone, a pulse sensor, and the like.

In addition, the state obtaining unit 120 may obtain an environmental state of the trainer 20 or the user 30.

Examples of the environmental state include time, position, illuminance, temperature, humidity, intensity of environmental sound, and the like.

The state obtaining unit 120 may further include a sensor for obtaining the environmental state described above.

### Feature Value Extraction Unit 130

The feature value extraction unit 130 according to the present embodiment extracts a feature value from sensor information regarding the physical state of the trainer 20 or the user 30 obtained by the state obtaining unit 120.

The feature value extraction unit 130 according to the present embodiment may extract a feature value using a technique widely used for processing of various types of sensor information.

In addition, in a case where the state obtaining unit 120 obtains sensor information regarding an environmental state, the feature value extraction unit 130 may also extract another feature value from the sensor information.

### Estimation Position Specification Unit 140

The estimation position specification unit 140 according to the present embodiment specifies a position at which a level of attention is to be estimated. The estimation position specification unit 140 may determine an estimation position in accordance with a rule determined in advance, or may determine an estimation position in accordance with an instruction from an operator, who is different from the trainer 20.

### Estimation Unit 150

The estimation unit 150 according to the present embodiment estimates a level of attention of a user cheering on output information of a certain type on the basis of a physical state of the user.

As described above, one of the features of the estimation unit 150 according to the present embodiment is to estimate a level of attention of a user using the estimation model 155 generated through deep reinforcement learning.

Furthermore, the estimation unit 150 according to the present embodiment may function as a learning unit that performs deep reinforcement learning of the estimation model 155.

Details of functions of the estimation unit 150 according to the present embodiment will be separately described.

### Storage Unit 160

The storage unit 160 according to the present embodiment stores information used by each of the components of the information processing apparatus 10.

The storage unit 160 stores, for example, various types of information regarding the estimation model 155 (network configuration, parameters, etc.).

### Output Control Unit 170

The output control unit 170 according to the present embodiment controls output of various types of information. For example, the output control unit 170 according to the present embodiment may control output of output information on the basis of the level of attention estimated by the estimation unit 150.

Specific examples of output control according to the present embodiment will be separately described.

### Display Unit 180

The display unit 180 according to the present embodiment displays visual information under the control of the output control unit 170. As described above, visual information is an example of the output information according to the present embodiment.

The display unit 180 according to the present embodiment may be a 2D display, a 3D display, a projector, or the like.

The configuration example of the information processing apparatus 10 according to the present embodiment has been described above. Note that the configuration described above with reference to FIG. 3 is merely an example, and the configuration of the information processing apparatus 10 according to the present embodiment is not limited to this example.

For example, the information processing apparatus 10 may further include an audio output unit that outputs auditory information, a tactile presentation unit that presents tactile information, and the like.

In addition, for example, although a case where the estimation unit 150 also functions as a training unit that performs the deep reinforcement learning of the estimation model 155 has been described above, a training unit that performs the deep reinforcement learning of the estimation model 155 and an estimation unit that performs the estimation using the estimation model 155 may be clearly separated from each other.

In addition, each function of the information processing apparatus 10 described above may be achieved through cooperation of a plurality of apparatuses. In this case, the plurality of apparatuses only needs to be able to communicate information over a network, and need not be set in the same place.

For example, the estimation unit 150 may be included in a server, and the output control unit 170 may be included in a local computer.

The system configuration according to the present embodiment may be flexibly modified in accordance with specifications, operations, or the like.

### 1.3. Procedure of Deep Reinforcement Learning of Estimation Model 155

Next, a procedure of the deep reinforcement learning of the estimation model 155 according to the present embodiment will be described in detail.

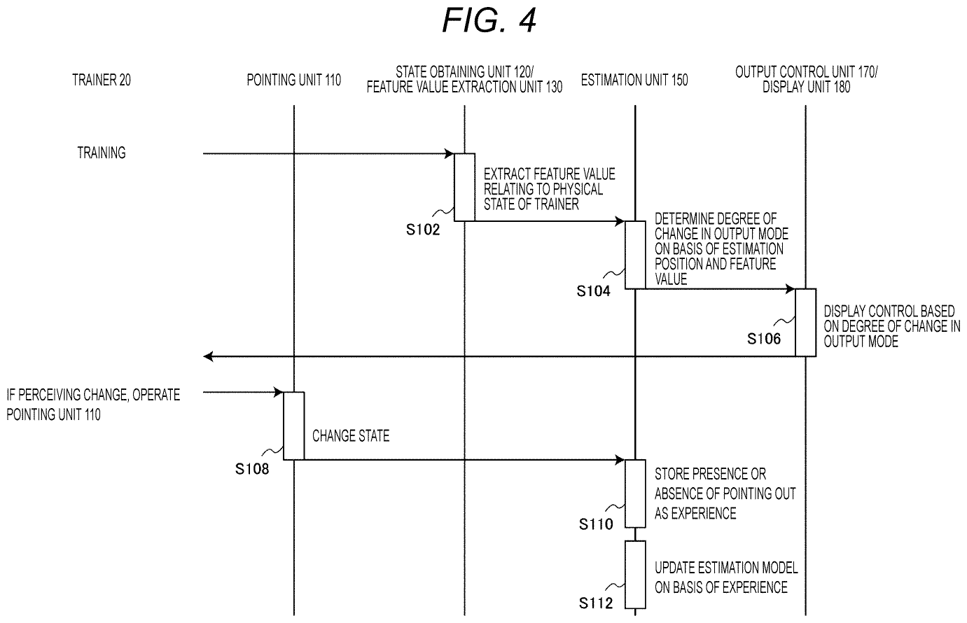

FIG. 4 is a sequence diagram illustrating an example of the procedure of the deep reinforcement learning of the estimation model 155 according to the present embodiment.

In the case of the example illustrated in FIG. 4, first, during training by the trainer 20, the state obtaining unit 120 obtains sensor information regarding the physical state of the trainer 20, and the feature value extraction unit 130 extracts a feature value from the sensor information (S102).

Here, in a case where the state obtaining unit 120 obtains sensor information regarding an environmental state, the feature value extraction unit 130 may also extract another feature value from the sensor information.

The feature value extracted by the feature value extraction unit 130 is input to the estimation model 155 included in the estimation unit 150.

Next, the estimation model 155 included in the estimation unit 150 uses the feature value extracted in step S102 and an estimated position specified by the estimation position specification unit 140 as inputs and determines (outputs) a degree of change in an output mode of output information (S104).

That is, it can be said that the estimation model 155 according to the present embodiment determines a degree of change in an output mode of training information also on the basis of an output (display) position of the training information.

At this time, since the feature value extracted from the sensor information regarding the environmental state is input to the estimation model 155, the estimation model 155 can be subjected to the learning while intensity of attention and a spatial extent of the attention are associated with not only the physical state of the trainer 20 but also the environmental state.

In addition, the estimation unit 150 may calculate a level of attention on the basis of the degree of change in the output mode of the output information determined by the estimation model 155.

For example, the estimation unit 150 according to the present embodiment calculates the level of attention on the basis of the degree of change in the output mode of the output information determined by the estimation model 155 and a maximum amount of change relating to the output mode.

Here, the maximum amount of change refers to a maximum value of the degree of change that can be determined by the estimation model 155. The maximum amount of change may be set in accordance with, for example, specifications of the display unit 180, performance of a processor, and the like.

The level of attention according to the present embodiment may be calculated using, for example, the following Expression (1) or Expression (2).

Level of attention={1−(degree of change in determined output mode)/(maximum amount of change)}*100[%] (1)

Level of attention={1−(degree of change in determined output mode)²/(maximum amount of change)²}*100[%] (2)

The above Expressions (1) and (2), however, are merely examples, and expressions used for calculating the level of attention according to the present embodiment are not limited to these examples. In addition, the level of attention according to the present embodiment need not necessarily be expressed in percentage.

Next, the output control unit 170 performs display control of the training information 310 on the basis of the degree of change in the output mode of the output information determined by the estimation model 155 (S106).

When the trainer 20 notices a change in the output mode, the trainer 20 operates the pointing unit 110 to change a state of the pointing unit 110 (S108).

Next, information regarding the state of the pointing unit 110 is input to the estimation model 155, and the estimation model 155 stores presence or absence of pointing out by the trainer 20 as an experience on the basis of the information (S110).

In addition, the estimation model 155 is updated on the basis of the above experience, and information regarding the estimation model 155 updated as necessary is stored in the storage unit 160 (S112).

The information processing apparatus 10 repeatedly performs the processing in steps S102 to S112 described above until the learning is completed.

Here, update of the estimation model 155 based on the experience of presence or absence of pointing out according to the present embodiment will be described in more detail.

The estimation model 155 according to the present embodiment may determine the degree of change in the output mode of the training information 310 using an objective function that differs depending on whether or not the trainer 20 has perceived the change in the output mode of the training information 310.

That is, one of features of the deep reinforcement learning according to the present embodiment is that a parameter update rule for the estimation model 155 is switched in accordance with presence or absence of pointing out by the trainer 20.

In a case where the trainer 20 has not perceived a change in the output mode of the training information 310, for example, the estimation model 155 according to the present embodiment may determine the degree of change in the output mode of the training information 310 such that an objective function corresponding to a positive number proportional to the degree of change in the output mode of the training information 310 is maximized.

In addition, in a case where the trainer 20 has perceived a change in the output mode of the training information 310, for example, the estimation model 155 according to the present embodiment may determine the degree of change in the output mode of the training information 310 such that an objective function corresponding to a negative number proportional to the degree of change in the output mode of the training information 310 is maximized.

As a result of the switching of the objective function described above, the estimation model 155 is updated in such a way as to take action to reduce the degree of change in the output mode in the case of presence of pointing out and increase the degree of change in the output mode in the case of absence of pointing out. This makes it possible to accurately estimate the intensity of attention.

The procedure of the deep reinforcement learning according to the present embodiment has been described in detail. Note that the procedure described with reference to FIG. 4 is merely an example, and a procedure of deep reinforcement learning according to the present embodiment is not limited to this example.

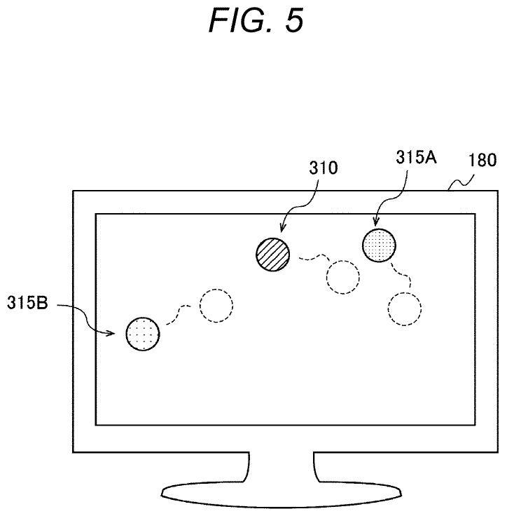

In step S106, for example, the output control unit 170 according to the present embodiment may control, as illustrated in FIG. 5, output of dummy information 315 of the same type (perceived by the same sense) as that of the training information 310, in addition to the training information 310.

At this time, the output control unit 170 may, for example, randomly change the output mode of the dummy information 315. The trainer 20, however, can distinguish the training information 310 from the dummy information.

In a case where only the training information 310 is output, the trainer 20 might react sensitively even to a small change in the output mode of the training information 310. By outputting the dummy information as described above, on the other hand, the trainer 20 is required to pay more attention to the training information 310, and estimation accuracy of the level of attention is expected to be improved.

### 1.4. Procedure of Calculation of Level of Attention That Uses Estimation Model 155 and Display Control Based on Level of Attention

Next, a procedure of calculation of a level of attention that uses the estimation model 155 and display control based on the level of attention according to the present embodiment will be described in detail.

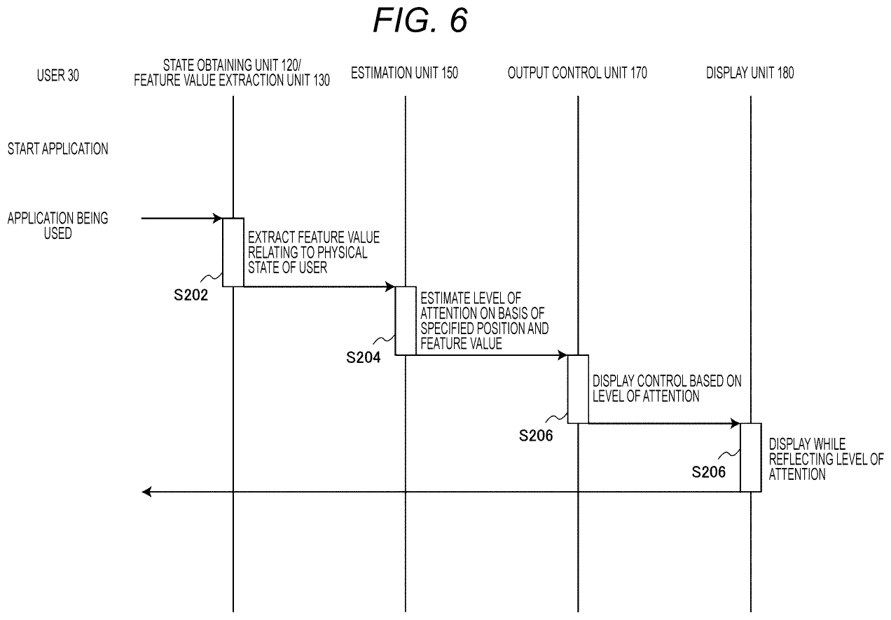

FIG. 6 is a sequence diagram illustrating an example of the procedure of the calculation of a level of attention that uses the estimation model 155 and the display control based on the level of attention according to the present embodiment.

In the case of the example illustrated in FIG. 6, first, an application that uses the estimation model 155 generated by the deep reinforcement learning described with reference to FIG. 4 is started.

During use of the application, the state obtaining unit 120 obtains sensor information regarding the physical state of the user 30, and the feature value extraction unit 130 extracts a feature value from the sensor information (S202).

Note that in a case where sensor information regarding an environmental state is used at a time of learning, sensor information regarding an environmental state is obtained and a feature value is extracted from the sensor information in step S202.

The feature value extracted by the feature value extraction unit 130 is input to the estimation model 155 included in the estimation unit 150.

Next, the estimation model 155 included in the estimation unit 150 uses the feature value extracted in step S102 and an estimation position specified by the estimation position specification unit 140 as inputs and determines (outputs) a degree of change in an output mode of output information. In addition, the estimation unit 150 calculates a level of attention of the user 30 on the basis of the degree of change in the output mode (S204).

The estimation unit 150 may calculate the level of attention using the above-described Expression (1) or Expression (2) or the like.

Next, the output control unit 170 performs display control based on the level of attention calculated in step S204 (S206), and the display unit 180 displays visual information that reflects the level of attention of the user 30 in accordance with the control by the output control unit 170 (S208).

### 1.5. Specific Examples of Display Control Based on Level of Attention

Next, the display control based on the level of attention of the user 30 according to the present embodiment will be described with reference to specific examples.

As described above, the output control unit 170 according to the present embodiment controls output of output information on the basis of the level of attention of the user 30 calculated by the estimation unit 150.

For example, the output control unit 170 according to the present embodiment may control dynamic display of levels of attention continuously estimated by the estimation unit 150.

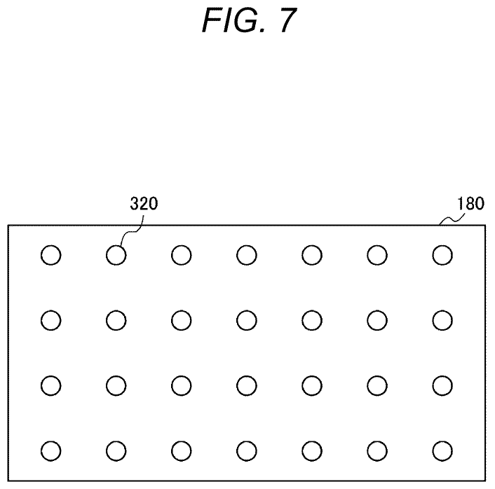

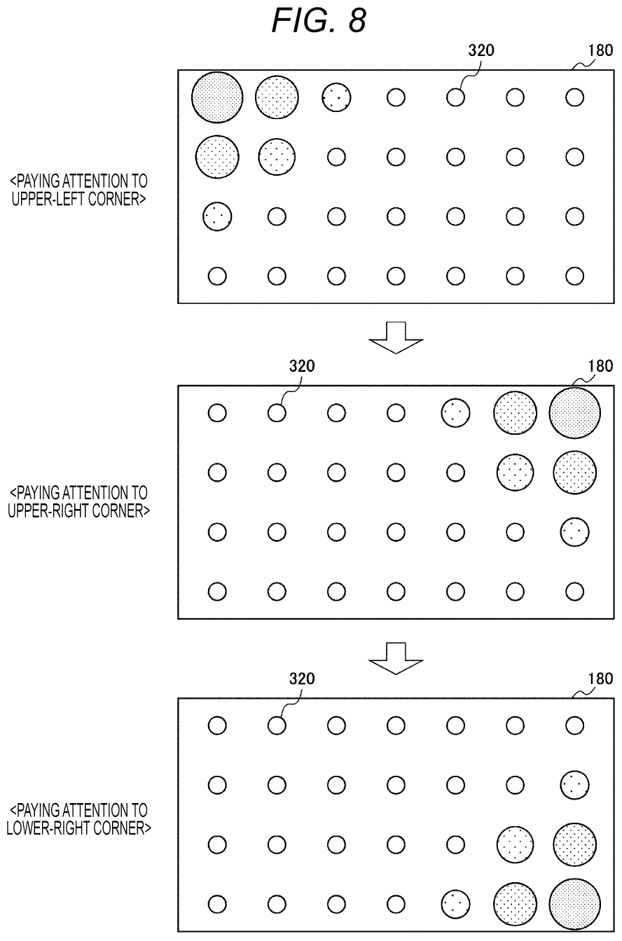

FIGS. 7 and 8 are diagrams for describing an example of the control of the dynamic display of the continuously estimated levels of attention according to the present embodiment.

FIG. 7 illustrates an example of display control in a situation where the user 30 is not paying attention to the display unit 180 at all.

In the case of the example illustrated in FIGS. 7 and 8, a total of 28 attention level visualization objects 320 in four rows and seven columns are displayed on the display unit 180 under the control of the output control unit 170.

The output control unit 170 controls a display mode of each of the attention level visualization objects 320 on the basis of the level of attention at a corresponding position calculated by the estimation unit 150.

For example, the output control unit 170 may perform control such that the attention level visualization object 320 is more highlighted as the corresponding calculated level of attention becomes higher.

For example, an upper part of FIG. 8 illustrates a display example in a case where the user 30 is paying attention to an upper-left corner of the display unit 180.

In this case, the output control unit 170 performs control such that the attention level visualization objects 320 located in an upper-left area of the display unit 180 are highlighted on the basis of the levels of attention calculated by the estimation unit 150.

In addition, a middle part of FIG. 8 illustrates a display example in a case where the user 30 is paying attention to an upper-right corner of the display unit 180.

In this case, the output control unit 170 performs control such that the attention level visualization objects 320 located in an upper-right area of the display unit 180 are highlighted on the basis of the levels of attention calculated by the estimation unit 150.

In addition, a lower part of FIG. 8 illustrates a display example in a case where the user 30 is paying attention to an upper-right corner of the display unit 180.

In this case, the output control unit 170 performs control such that the attention level visualization objects 320 located in the lower-right area of the display unit 180 are highlighted on the basis of the levels of attention calculated by the estimation unit 150.

Note that FIG. 8 illustrates a case where the output control unit 170 performs control such that the attention level visualization object 320 becomes larger and density of a dot pattern becomes higher as the corresponding level of attention becomes higher.

The highlight illustrated in FIG. 8, however, is merely an example, and the attention level visualization objects 320 may be highlighted using color, brightness, again, blinking speed, or the like.

With such highlight of the attention level visualization objects 320 based on the levels of attention, it is possible to display, in real-time, an area to which the user 30 is paying attention and to intuitively grasp the area to which the user 30 is paying attention.

Note that the attention level visualization objects 320 according to the present embodiment may be superimposed upon visual information of another type.

In addition, the output control unit 170 according to the present embodiment may control, on the basis of a level of attention to each of a plurality of pieces of content that is being output, output of the piece of content.

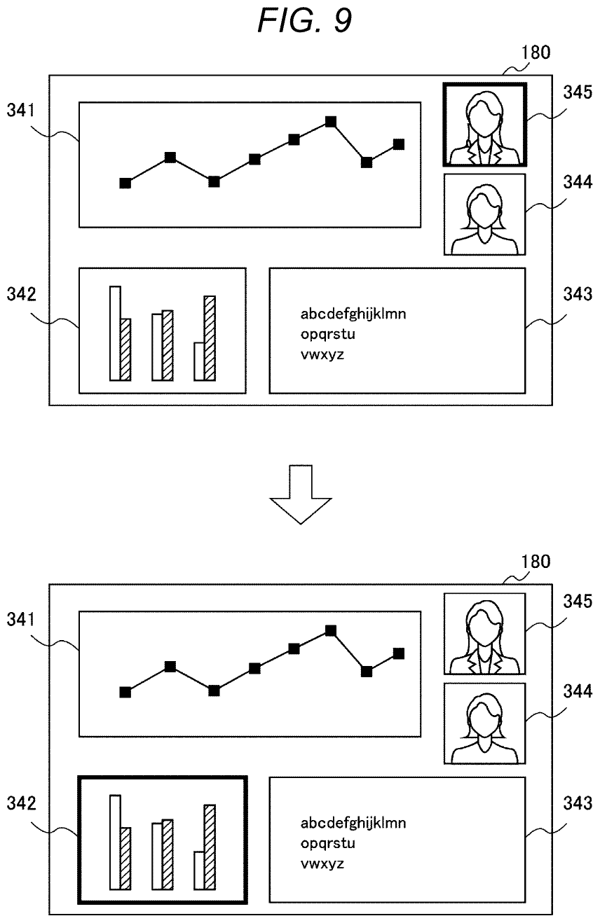

FIG. 9 is a diagram for describing an example of the output control of each of a plurality of pieces of content based on a level of attention to the piece of content according to the present embodiment.

FIG. 9 illustrates an example of display control of the display unit 180 on a consultant side while an online consultation is being held using a web conference system.

In the case of the example illustrated in FIG. 9, the output control unit 170 performs display control on the basis of a level of attention to each of a plurality of pieces of content in a first graph area 341, a second graph area 342, a text area 343, a client image area 344, and a consultant image area 345.

For example, an upper part of FIG. 9 illustrates a situation where a client (user 30) is paying the most attention to the consultant image area 345. In this case, the output control unit 170 may perform control such that an outer edge of the consultant image area 345 is highlighted compared to outer edges of the other pieces of content.

In addition, for example, a lower part of FIG. 9 illustrates a situation where the client (user 30) is paying the most attention to the second graph area 342. In this case, the output control unit 170 may perform control such that an outer edge of the second graph area 342 is highlighted compared to the outer edges of the other pieces of content.

Note that presentation of a level of attention to each piece of content is not limited to the highlight of an outer edge, and a level of attention to each piece of content may be presented as changes in one of various display modes including color, brightness, blinking, and the like.

In addition, although FIG. 9 illustrates a case where priority is given to visibility and only a piece of content to which the client (user 30) is paying the most attention is highlighted, the output control unit 170 may simultaneously control display modes of a plurality of pieces of content in accordance with corresponding levels of attention for the plurality of pieces of content.

In addition, the output control unit 170 may explicitly present a level of attention to each piece of content in a numerical value.

With the display control described with reference to FIG. 9, an explaining side (e.g., a consultant) can intuitively grasp which piece of content a listening side (e.g., a client) is paying attention, and explanation can be given more effectively and more efficiently.

In addition, the output control unit 170 according to the present embodiment may control, for example, behavior of a display object, such as a character in a game application, on the basis of a calculated level of attention.

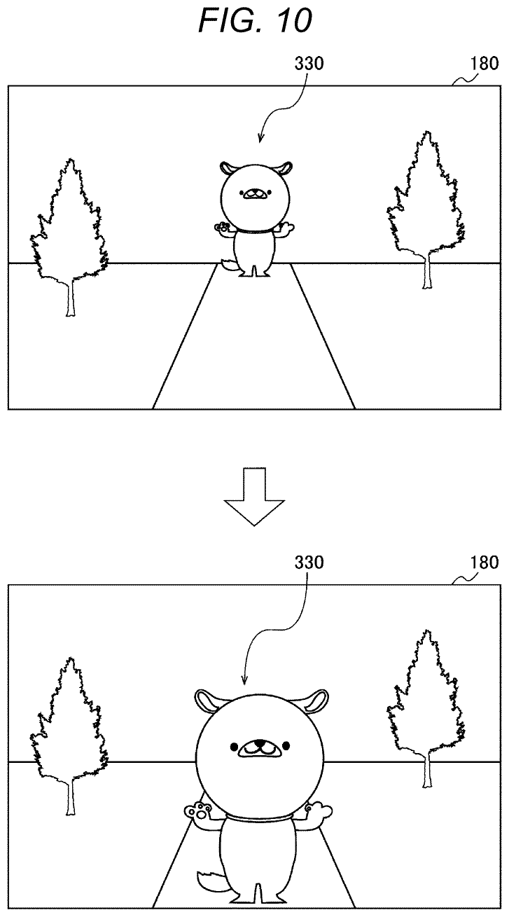

FIG. 10 is a diagram for describing an example of display control of a display object based on a level of attention according to the present embodiment.

FIG. 10 illustrates a situation where a display object 330 corresponding to a certain character approaches another character operated by the user 30 in a game application.

In a case where a level of attention of the user 30 to the display object 330 is high (e.g., in a case where the level of attention exceeds a threshold), for example, the output control unit 170 according to the present embodiment may perform control such that the display object 330 behaves as described above.

With the control as described above, even if the user 30 does not intentionally control his/her character such that the character approaches and talks to the character corresponding to the display object 330, it is possible to cause the character corresponding to the display object 330 to approach and talk to the character of the user 30.

Conversely, in a case where the level of attention of the user 30 to the display object 330 is low (e.g., in a case where the level of attention falls below the threshold), for example, the output control unit 170 may perform control such that the display object 330 behaves as described above.

With the control described above, in a case where the user is inattentive, it is possible to cause the enemy character corresponding to the display object 330 to, for example, approach the character controlled by the user 30.

In addition, with the control described above, it is possible to easily realize a situation such as Statues game (e.g., Red Light, Green Light in North America) played in various places of the world.

In addition, the output control unit 170 according to the present embodiment may control an output position of output information especially relating to notification or the like on the basis of the level of attention of the user 30.

In a case of displaying an icon indicating reception of a mail of a high level of importance or urgency or the like, for example, the output control unit 170 may display the icon in an area on the display unit 180 to which the user 30 is paying attention (an area where the level of attention exceeds a threshold).

With the control described above, it is possible to effectively reduce a possibility that the user 30 overlooks information of a high level of importance or urgency.

Conversely, in a case of displaying an icon indicating reception of a mail of a low level of importance or urgency or the like, for example, the output control unit 170 may display the icon in an area on the display unit 180 to which the user 30 is not paying attention (an area where the level of attention falls below a threshold).

With the control described above, it is possible to effectively reduce a possibility of making the user uncomfortable by, for example, unnecessarily attracting attention of the user 30 who is looking at another piece of output information on the display unit 180.

In addition, the output control unit 170 according to the present embodiment may control output of output information on the basis of a level of attention of each of a plurality of users 30.

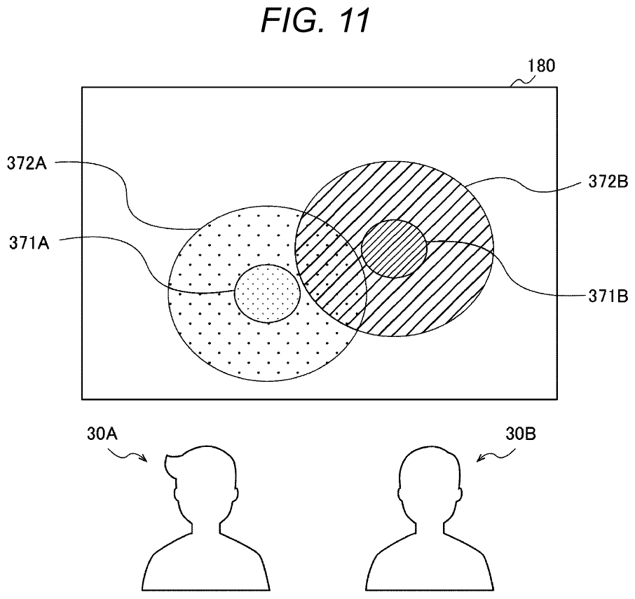

FIG. 11 is a diagram for describing an example of output control based on a level of attention of each of a plurality of users 30 according to the present embodiment.

FIG. 11 illustrates a high attention level area 371A and a low attention level area 372A of a user 30A and a high attention level area 371B and a low attention level area 372B of a user 30B on the display unit 180.

Here, the high attention level area 371A indicated by dense dots may be an area where the level of attention of the user 30A exceeds a first threshold. In addition, the high attention level area 371B indicated by dense diagonal lines may be an area where the level of attention of the user 30B exceeds the first threshold.

In addition, the low attention level area 372A indicated by sparse dots may be an area where the level of attention of the user 30A is lower than or equal to the first threshold and exceeds a second threshold. In addition, the low attention level area 372B indicated by sparse diagonal lines may be an area where the level of attention of the user 30B is lower than or equal to the first threshold and exceeds the second threshold.

In a case where information important to both the users 30A and 30B is displayed in the above situation, the output control unit 170 may display the information in an area where the low attention level areas 372A and 372B overlap.

With the control described above, a possibility that both the users 30A and 30B overlook important information can be effectively reduced.

Note that in a case where there is an area where the high attention level areas 371A and 371B overlap, the output control unit 170 may display the information in the area, instead.

In a case where information that is important to the user 30A but is not important to the user 30B is displayed, on the other hand, the output control unit 170 may display the information in the high attention level area 371A. Similarly, in a case where information that is important to the user 30B but is not important to the user 30A is displayed, on the other hand, the output control unit 170 may display the information in the high attention level area 371B.

With the control described above, even in a case where there is a plurality of users 30, it is possible, for example, to notify only a target user 30 without disturbing experience of non-target users 30.

The control of output information based on a level of attention according to the present embodiment has been described above with reference to specific examples. Note that the output control unit 170 according to the present embodiment can perform various types of output control other than the examples described above.

For example, the output control unit 170 can also perform control such as displaying an advertisement in an area where the level of attention of the user 30 is high.

Furthermore, for example, the output control unit 170 can also perform display control for attracting attention to an area where the level of attention of the user 30 who is driving is low.

The output control based on the level of attention according to the present embodiment can be flexibly modified in accordance with specifications of an application or the like.

In addition, a level of attention calculated by an information processing method according to the present embodiment can be used as knowledge in UI design and the like.

In addition, although a case where output information is visual information has been described above as a main example, the output information according to the present embodiment may be auditory information, tactile information, or the like, instead.

With the information processing method according to the present embodiment, it is possible to achieve effective output control of auditory information or tactile information based on intensity of attention of the user 30 or the like.

### 2. Hardware Configuration Example

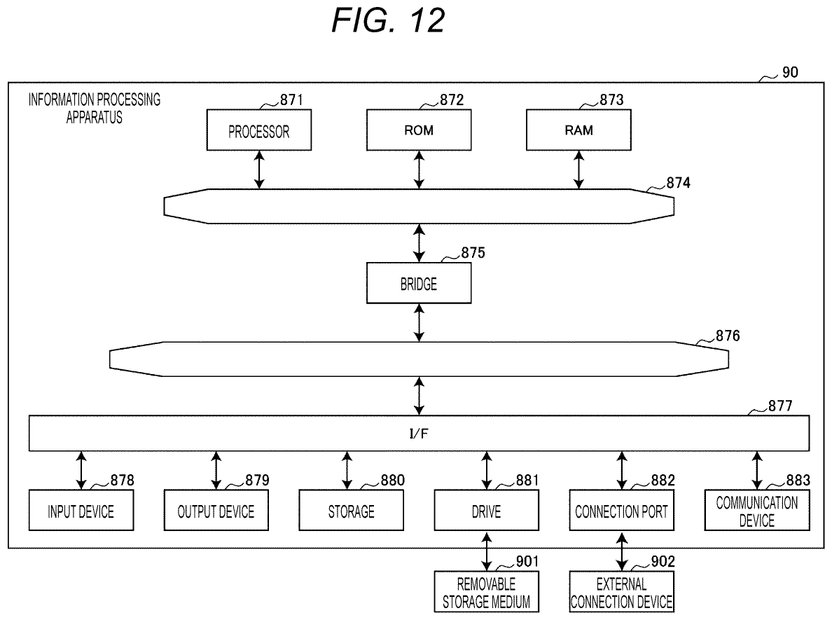

Next, an example of hardware configuration of an information processing apparatus 90 according to the embodiment of the present disclosure will be described. FIG. 12 is a block diagram illustrating the example of the hardware configuration of the information processing apparatus 90 according to the embodiment of the present disclosure.

The information processing apparatus 90 may be an apparatus having a hardware configuration equivalent to that of the information processing apparatus 10 according to the embodiment of the present disclosure.

As illustrated in FIG. 12, the information processing apparatus 90 includes, for example, a processor 871, a ROM 872, a RAM 873, a host bus 874, a bridge 875, an external bus 876, an interface 877, an input device 878, an output device 879, a storage 880, a drive 881, a connection port 882, and a communication device 883. Note that the hardware configuration illustrated here is an example, and a subset of the components may be omitted. In addition, components other than those illustrated here may be further included.

### Processor 871

The processor 871 functions as, for example, an arithmetic processing device or a control device, and controls overall operation of each component or a part thereof on the basis of various programs stored in the ROM 872, the RAM 873, the storage 880, or a removable storage medium 901.

### ROM 872 and RAM 873

The ROM 872 is a means for storing programs to be read by the processor 871, data to be used for processing, and the like. The RAM 873 temporarily or permanently stores, for example, program to be read by the processor 871, various parameters that appropriately change when the programs are executed, and the like.

### Host Bus 874, Bridge 875, External Bus 876, and Interface 877

The processor 871, the ROM 872, and the RAM 873 are mutually connected via, for example, the host bus 874 capable of high-speed data transmission. The host bus 874, on the other hand, is connected, for example, to the external bus 876 having a relatively low data transmission speed via the bridge 875. In addition, the external bus 876 is connected to various components via the interface 877.

### Input Device 878

As the input device 878, for example, a mouse, a keyboard, a touch panel, a button, a switch, a lever, and/or the like are used. Furthermore, as the input device 878, a remote controller (hereinafter referred to as a remote) capable of transmitting a control signal using infrared rays or other radio waves may be used. In addition, the input device 878 includes a voice input device such as a microphone.

### Output Device 879

The output device 879 is a device capable of visually or auditorily notifying a user of obtained information, such as a display device typified by a cathode ray tube (CRT), an LCD, an organic EL, or the like, an audio output device typified by a speaker, a headphone, or the like, a printer, a mobile phone, a facsimile, or the like. In addition, the output device 879 in the present disclosure includes various vibration devices capable of outputting tactile stimuli.

### Storage 880

The storage 880 is a device for storing various types of data. As the storage 880, for example, a magnetic storage device such as a hard disk drive (HDD) or the like, a semiconductor storage device, an optical storage device, a magneto-optical storage device, or the like is used.

### Drive 881

The drive 881 is, for example, a device that reads information stored in the removable storage medium 901 such as a magnetic disk, an optical disc, a magneto-optical disk, or a semiconductor memory, or writes information to the removable storage medium 901.

### Removable Storage Medium 901

The removable storage medium 901 is, for example, a DVD medium, a Blu-ray (registered trademark) medium, an HD DVD medium, one of various semiconductor storage media, or the like. It is needless to say that the removable storage medium 901 may be, for example, an IC card on which a non-contact IC chip is mounted, an electronic device, or the like.

### Connection Port 882

The connection port 882 is, for example, a port for connecting an external connection device 902 such as a universal serial bus (USB) port, an IEEE 1394 port, a small computer system interface (SCSI), an RS-232C port, or an optical audio terminal.

### External Connection Device 902

The external connection device 902 is, for example, a printer, a portable music player, a digital camera, a digital video camera, an IC recorder, or the like.

### Communication Device 883

The communication device 883 is a communication device for connecting to a network and is, for example, a communication card for a wired or wireless local area network (LAN), Bluetooth (registered trademark), or wireless USB (WUSB), a router for optical communication, a router for asymmetric digital subscriber line (ADSL), a modem for one of various types of communication, or the like.

### 3. Conclusion

As described above, the information processing apparatus 10 according to the embodiment of the present disclosure includes the estimation unit 150 that estimates a level of attention of a user to output information of a certain type on the basis of a physical state of the user. In addition, one of features of the estimation unit 150 according to the embodiment of the present disclosure is to estimate a level of attention using an estimation model 155 that determines a degree of change in an output mode of output information on the basis of a physical state of a trainer and an experience of whether or not the trainer has perceived a change in an output mode of training information of the same type as that of the output information in a case where the output mode has been changed.

With the above configuration, it is possible to accurately estimate intensity of attention of the user and a spatial extent of the attention.

Although a preferred embodiment of the present disclosure has been described above in detail with reference to the accompanying drawings, the technical scope of the present disclosure is not limited to this example. It is obvious that those with ordinary knowledge in the technical field of the present disclosure can conceive various alterations or corrections within the scope of the technical idea recited in the claims, and it is naturally understood that these alterations or corrections also fall within the technical scope of the present disclosure.

In addition, each step relating to a process described in the present disclosure is not necessarily processed in time series in the order described in a flowchart or a sequence diagram. For example, individual steps relating to a process performed by each apparatus may be processed in order different from the described one, or may be processed in parallel with each other.

In addition, a series of processing operations performed by each apparatus described in the present disclosure may be achieved by a program stored in a non-transitory computer readable storage medium. When the computer executes each program, for example, the program is loaded into the RAM and executed by a processor such as a CPU. The storage medium is, for example, a magnetic disk, an optical disc, a magneto-optical disk, a flash memory, or the like. In addition, the program may be distributed, for example, over a network without using a storage medium, instead.

In addition, the effects disclosed herein are merely illustrative or exemplary, and not restrictive. That is, the technique in the present disclosure can produce other effects that are apparent to those skilled in the art from the description herein in addition to, or instead of, the effects described above.

Note that the following configurations also pertain to the technological scope of the present disclosure.
(1)

An information processing apparatus including:
an estimation unit that estimates a level of attention of a user to output information of a certain type on a basis of a physical state of the user,
in which the estimation unit estimates the level of attention using an estimation model that determines a degree of change in an output mode of the output information on a basis of a physical state of a trainer and an experience of whether or not the trainer has perceived a change in an output mode of training information of the same type as that of the output information in a case where the output mode has been changed.
(2)

The information processing apparatus according to (1), in which
the estimation model determines, on a basis of the experience, a degree of change in the output mode of the training information such that the trainer will not perceive the change in the output mode of the training information.
(3)

The information processing apparatus according to (2), in which
the estimation model determines the degree of change in the output mode of the training information using an objective function that differs depending on whether or not the trainer has perceived the change in the output mode of the training information.
(4)

The information processing apparatus according to (3), in which
in a case where the trainer has not perceived the change in the output mode of the training information, the estimation model determines the degree of change in the output mode of the training information such that an objective function corresponding to a positive number proportional to the degree of change in the output mode of the training information is maximized.
(5)

The information processing apparatus according to (3) or (4), in which
in a case where the trainer has perceived the change in the output mode of the training information, the estimation model determines the degree of change in the output mode of the training information such that an objective function corresponding to a negative number proportional to the degree of change in the output mode of the training information is maximized.
(6)

The information processing apparatus according to any one of (1) to (5), in which,
in a case where a feature value extracted from sensor information indicating the physical state of the user is input to the estimation model, the estimation unit calculates the level of attention on a basis of the degree of change in the output mode of the output information output from the estimation model.
(7)

The information processing apparatus according to (6), in which
the estimation unit calculates the level of attention on a basis of the degree of change in the output mode of the output information output from the estimation model and a maximum amount of change relating to the output mode.
(8)

The information processing apparatus according to any one of (1) to (7), in which
the output information includes visual information.
(9)

The information processing apparatus according to (8), in which
the estimation model determines the degree of change in the output mode of the training information also on a basis of a display position of the training information.
(10)

The information processing apparatus according to (8), in which
the output mode of the training information includes a display position.
(11)

The information processing apparatus according to (6), in which
the sensor information includes an image obtained by capturing an image of the user's face.
(12)

The information processing apparatus according to any one of (1) to (11), further including:
an output control unit that controls output of the output information on a basis of the level of attention estimated by the estimation unit.
(13)

The information processing apparatus according to (12), in which
the output control unit controls an output position of the output information on a basis of the level of attention.
(14)

The information processing apparatus according to (12) or (13), in which
the output control unit controls behavior of a display object on a basis of the level of attention.
(15)

The information processing apparatus according to any one of (12) to (14), in which
the output control unit controls, on a basis of the level of attention to each of a plurality of pieces of content that is being output, output of the piece of content.
(16)

The information processing apparatus according to (12), in which
the output control unit controls dynamic display of levels of attention continuously estimated by the estimation unit.
(17)

The information processing apparatus according to any one of (12) to (16), in which
the output control unit controls the output of the output information on a basis of the level of attention of each of a plurality of users.
(18)

An information processing method including:
estimating, using a processor, a level of attention of a user to output information of a certain type on a basis of a physical state of the user,
in which, in the estimating, the level of attention is estimated using an estimation model that determines a degree of change in an output mode of the output information on a basis of a physical state of a trainer and an experience of whether or not the trainer has perceived a change in an output mode of training information of the same type as that of the output information in a case where the output mode has been changed.
(19)

A program causing a computer to function as:
an information processing apparatus including
an estimation unit that estimates a level of attention of a user to output information of a certain type on a basis of a physical state of the user,
in which the estimation unit estimates the level of attention using an estimation model that determines a degree of change in an output mode of the output information on a basis of a physical state of a trainer and an experience of whether or not the trainer has perceived a change in an output mode of training information of the same type as that of the output information in a case where the output mode has been changed.

### REFERENCE SIGNS LIST

10 Information processing apparatus
110 Pointing unit
120 State obtaining unit
130 Feature value extraction unit
140 Estimation position specification unit
150 Estimation unit
155 Estimation model
160 Storage unit
170 Output control unit
180 Display unit

1. An information processing apparatus comprising:
an estimation unit that estimates a level of attention of a user to output information of a certain type on a basis of a physical state of the user,
wherein the estimation unit estimates the level of attention using an estimation model that determines a degree of change in an output mode of the output information on a basis of a physical state of a trainer and an experience of whether or not the trainer has perceived a change in an output mode of training information of a same type as that of the output information in a case where the output mode has been changed.

2. The information processing apparatus according to claim 1, wherein
the estimation model determines, on a basis of the experience, a degree of change in the output mode of the training information such that the trainer will not perceive the change in the output mode of the training information.

3. The information processing apparatus according to claim 2, wherein
the estimation model determines the degree of change in the output mode of the training information using an objective function that differs depending on whether or not the trainer has perceived the change in the output mode of the training information.

4. The information processing apparatus according to claim 3, wherein
in a case where the trainer has not perceived the change in the output mode of the training information, the estimation model determines the degree of change in the output mode of the training information such that an objective function corresponding to a positive number proportional to the degree of change in the output mode of the training information is maximized.

5. The information processing apparatus according to claim 3, wherein
in a case where the trainer has perceived the change in the output mode of the training information, the estimation model determines the degree of change in the output mode of the training information such that an objective function corresponding to a negative number proportional to the degree of change in the output mode of the training information is maximized.

6. The information processing apparatus according to claim 1, wherein
in a case where a feature value extracted from sensor information indicating the physical state of the user is input to the estimation model, the estimation unit calculates the level of attention on a basis of the degree of change in the output mode of the output information output from the estimation model.

7. The information processing apparatus according to claim 6, wherein
the estimation unit calculates the level of attention on a basis of the degree of change in the output mode of the output information output from the estimation model and a maximum amount of change relating to the output mode.

8. The information processing apparatus according to claim 1, wherein
the output information includes visual information.

9. The information processing apparatus according to claim 8, wherein
the estimation model determines the degree of change in the output mode of the training information also on a basis of a display position of the training information.

10. The information processing apparatus according to claim 8, wherein
the output mode of the training information includes a display position.

11. The information processing apparatus according to claim 6, wherein
the sensor information includes an image obtained by capturing an image of the user's face.

12. The information processing apparatus according to claim 1, further comprising:
an output control unit that controls output of the output information on a basis of the level of attention estimated by the estimation unit.

13. The information processing apparatus according to claim 12, wherein
the output control unit controls an output position of the output information on a basis of the level of attention.

14. The information processing apparatus according to claim 12, wherein
the output control unit controls behavior of a display object on a basis of the level of attention.

15. The information processing apparatus according to claim 12, wherein
the output control unit controls, on a basis of the level of attention to each of a plurality of pieces of content that is being output, output of the piece of content.

16. The information processing apparatus according to claim 12, wherein
the output control unit controls dynamic display of levels of attention continuously estimated by the estimation unit.

17. The information processing apparatus according to claim 12, wherein
the output control unit controls the output of the output information on a basis of the level of attention of each of a plurality of users.

18. An information processing method comprising:
estimating, using a processor, a level of attention of a user to output information of a certain type on a basis of a physical state of the user,
wherein, in the estimating, the level of attention is estimated using an estimation model that determines a degree of change in an output mode of the output information on a basis of a physical state of a trainer and an experience of whether or not the trainer has perceived a change in an output mode of training information of a same type as that of the output information in a case where the output mode has been changed.

19. A program causing a computer to function as:
an information processing apparatus comprising
an estimation unit that estimates a level of attention of a user to output information of a certain type on a basis of a physical state of the user,
wherein the estimation unit estimates the level of attention using an estimation model that determines a degree of change in an output mode of the output information on a basis of a physical state of a trainer and an experience of whether or not the trainer has perceived a change in an output mode of training information of a same type as that of the output information in a case where the output mode has been changed.
